(19) United States
(12) Patent Application Publication
(10) Pub. No.: US 2015/0342299 A1
(43) Pub. Date: Dec. 3, 2015

(54) Anti-Slip Safety Device

(71) Applicant: Han-Ching Wu, Taichunq City (TW)

(72) Inventor: Han-Ching Wu, Taichunq City (TW)

(21) Appl. No.: 14/288,409

(22) Filed: May 28, 2014

(51) Int. Cl. A43B 13/22; B60C 11/20; B60C 11/14

(52) U.S. Cl. CPC A43B 13/223; B60C 11/14; B60C 11/20

(57) ABSTRACT

The present invention relates to an anti-slip safety device, which is a structural design for providing anti-slip safety for a rubber/plastic surface layer, particularly a snow shoe and a tire, to provide an effect of anti-slip ground-engaging for use safety, and which generally includes anti-slip elements made of a stiff material or a metal, arranged in a spaced manner along a longitudinal axis by being deposited in spacing troughs formed in an arrangement of slip-resistant embossed patterns provided on a sole undersurface or a tire tread and integrally molded with a molding rubber/plastic material in such a way to form raised edge faces that are slightly outward projecting portions having a height substantially flush with the embossed patterns, whereby for walking on a snowed and iced surface, the stiff raised edge faces may successively bite into the snowed and iced surface to achieve an effect of anti-slip safety for use.

### (a) TECHNICAL FIELD OF THE INVENTION

The present invention generally relates to an anti-slip safety device, where an anti-slip element is designed as an arrangement of circular rings or helical arrangement to directly and integrally molded with a structural body, such as shoe sole and a tire, which is made of a rubber/plastic material so as to achieve an effect of safe and stable bonding, with raised edge faces of the anti-slip element that slightly project out and raised patterns for ground surface compliance being made to have substantially the same height for positively biting into a surface layer of snow and ice and achieve a practical advantage of anti-slip safety.

### (b) DESCRIPTION OF THE PRIOR ART

Heretofore, when a person is walking on an ice or snow surface, due to the nature of the iced surface being rigid and slippery, unless the outsoles are provided with special spikes or comprise a design of a special stiff rough-patterned surface, regular shoes are incapable of providing safe and stable walking. Thus, walking in a snow surface requires wearing shoes having a special design of snow spike. As to automobile, a safety means of snow chain must be attached; otherwise there may be safety concerns of movement due to skidding. Considering the anti-slip design that is adopted in snow shoes or on-ice shoes, such as the prior art reference of U.S. Pat. No. 5,634,283, a metal-made T-shaped shoe spike is used, having a bottom end forming a slender bar extending out, which is placed in a mold for molding rubber sole in order to be directly molded with the rubber material of the shoe sole. Since the metal-made shoe spike has a great rigidity, when it is molded and wrapped in the rubber shoe sole, if the material of the shoe sole does not have a sufficient thickness and the elasticity of the rubber does not provide sufficient rigidity and stiffness, heavy stepping or uneven road surface may cause an instantaneous reaction force that is unduly large. The shoe spike is acted upon by the reaction force so that the spike head may partially project into the interior of the shoe, showing a raised configuration, which may lead to discomfort of the foot sole and may even hurt the foot sole in a severe condition. During molding and manufacturing, the shoe spikes must be inserted, one by one, into the interior of the shoe mold to be positioned and fixed therein. This is time consuming and also skill dependent. When rubber or plastic is filled to proceed with the molding operation, the flowing of the softened rubber or plastic may cause inclining or shifting or the shoe spikes in the molding operation due to the shoe spikes being not inserted into a sufficient depth. (Based on the location where the spike is inserted into the shoe mold, this may be just applicable to the length of projection of the spikes after molding.) Such an inclined condition, when occurring, may severely affect the effect of ground-gripping and slip resistance of a stepping-down shoe sole. The depth of the spike inserted into the mold is increased to improve the stability of positioning, such as the prior art reference of EP 1 290 958 A3. A hole that receives a shoe spike positioned in the mold to insert therein is provided with a projection ring shape to form a relatively long stiff insertion wrapping space for preventing the shoe spike from being shifted by being pushed by the plastic material thereby ensuring correctly aligned insertion. However, for such a change in design of the mold, as mentioned above, the insertion and assembled depth is relatively long, or aid for assisting insertion and positioning is used. However, considering the mutually wrapping length of the shoe spike and the shoe sole, there is apparently an exposed hollow portion formed in the bottom of the wrapping. Due to the insufficiency of the wrapping length, the stability of bonding the shoe spike is not sufficient. Particularly, the metal-make spike stem and the soft and resilient shoe sole are generally hard to completely bond together so that the reaction force induced in the use thereof may readily cause the spike to detach. Thus, some manufacturers apply hardening treatment to the shoe sole material. The rubber material for the shoe sole would become excessively rigid, making the resiliency and comfortableness of wearing of the shoe sole insufficient. This has been the issue and blind spot of the development and manufacture.

Further, although the metal-made ant-slip shoe spike has sufficient stiffness; however, considering bonding with the rubber or plastic shoe sole and wearing comfortableness, in view of the T-shaped slender stem structure, assembling the shoe sole may easily lead to concerns about practicability and wearing safety. Considering the convention rigid anti-slip design where the spike tip of the shoe spike projects out of the sole surface, when moving into an indoor space, it may get slipping on a rigid floor surface, leading to a dangerous situation and scratching the floor surface. Thus, it often needs to change shoes. Further, for the known structural design of the anti-slip shoe spike, the fact that it does not suit the need for diversified uses should be improved in order to achieve a positive effect of anti-slip and avoid the concern and drawbacks that it cannot be used both indoors and outdoors. This is the primary cause for the development and creation of the present invention.

### SUMMARY OF THE INVENTION

The present inventor is a professional shoe sole material supplies and designer and is fully aware of the issue that the manufacture and use of the conventional anti-slip shoe sole of a snow shoe are generally not practical and do not meet the requirement for safety concern so that based on the years' experience of development and manufacture of shoe sole material, taking the need of safety in the assembling and use of anti-slip measure, an anti-slip safety device is developed and designed in the present invention in such a way that ring anti-slip elements that are made in advance of a rigid material and are successively arranged in a spaced manner are molded with a shoe sole in order to effectively overcome the concern about insufficiency of rigidity, achieving easy manufacture and a positive effect of slip resistance, thereby completely improving the drawback of being impractical of the conventional spike based anti-slip structure.

The primary object of the present invention is that an anti-slip element is composed of stiff arranged successive rings directly embedded in a ground contacting surface of a rubber/plastic shoe sole to be molded in combination with decorative patterns of the main body, achieving practical advantages of easy molding and secured and positive bonding, whereby a purpose and effectiveness of use of positively achieving safety and slip resistance can be achieved with slip resistance provided with successive, spaced, and arranged raised edge faces.

The foregoing objectives and summary provide only a brief introduction to the present invention. To fully appreciate these and other objects of the present invention as well as the invention itself; all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an anti-slip structure of a shoe sole according to the present invention.

FIG. 2 is a plan view showing an arrangement of shoe sole anti-slip elements according to the present invention.

FIG. 3 is a schematic view, in an enlarged form, showing assembling of the anti-slip element according to the present invention.

FIG. 4 is a schematic view showing an assembled arrangement of the anti-slip element according to the present invention.

FIG. 5 is a plan view showing another arrangement of shoe sole anti-slip elements according to the present invention.

FIG. 6 is a schematic view showing the ring anti-slip element placed in a mold.

FIG. 7 is a schematic view showing an anti-slip element of the present invention used in the molding of a curved surface of a tire.

FIG. 8 is a schematic view showing the anti-slip elements of the present invention used in a tire tread.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

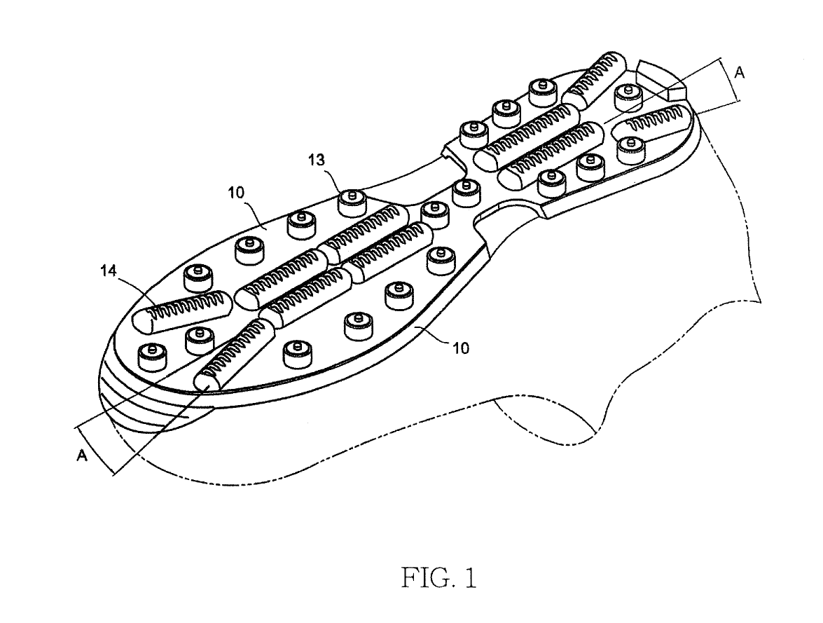

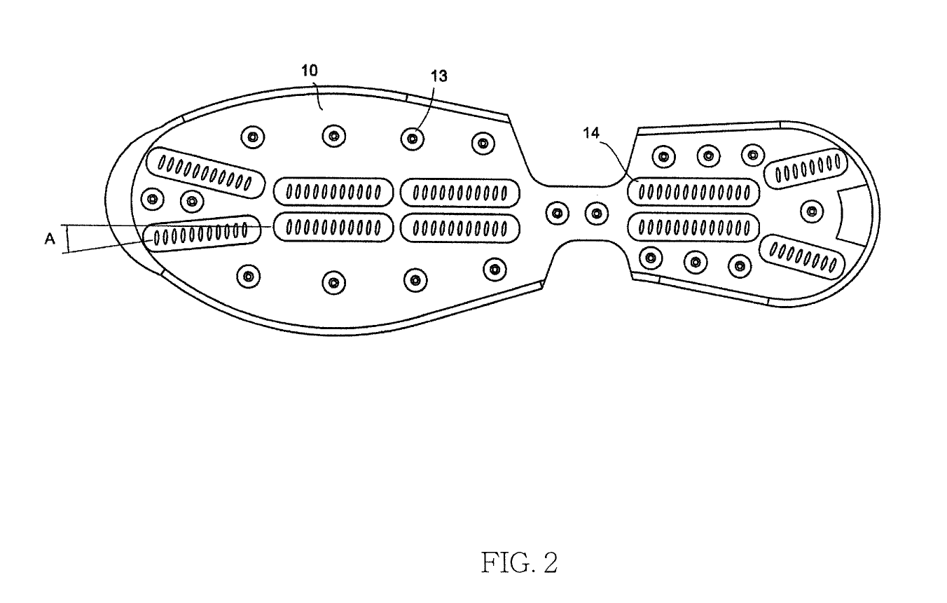

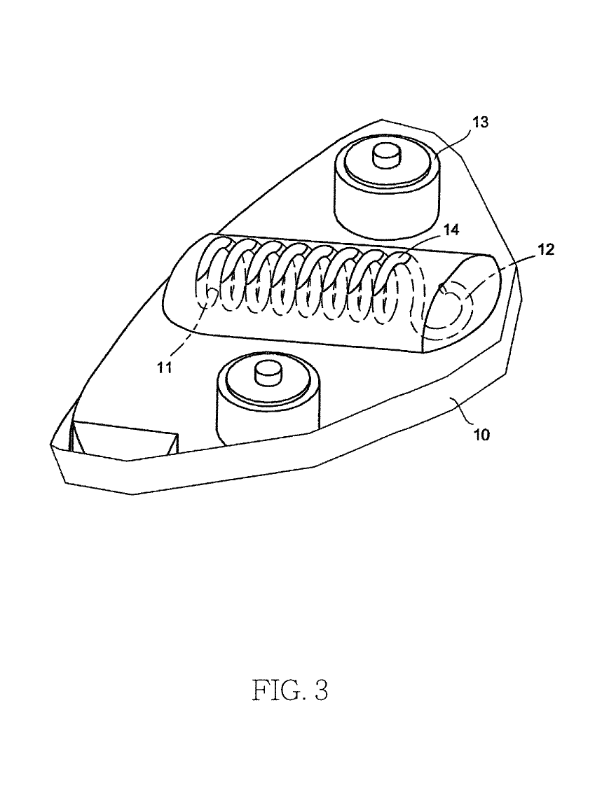

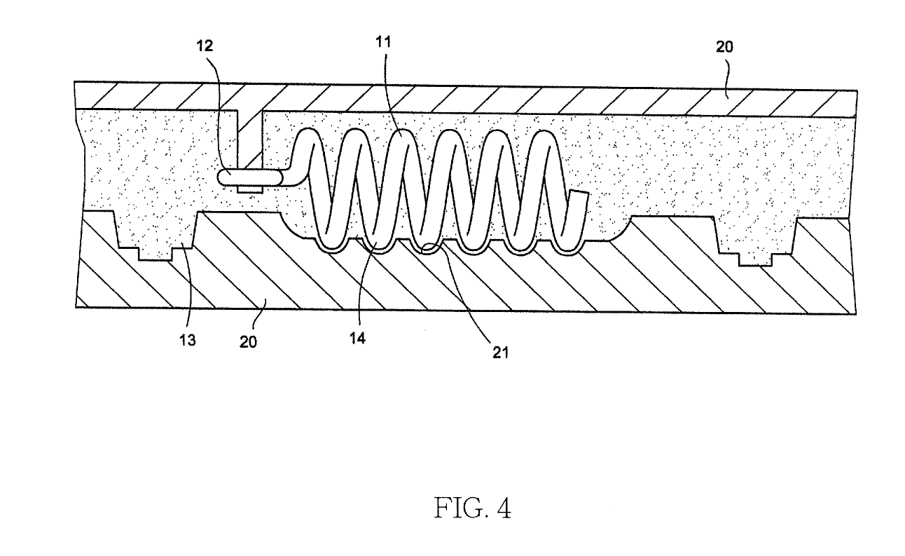

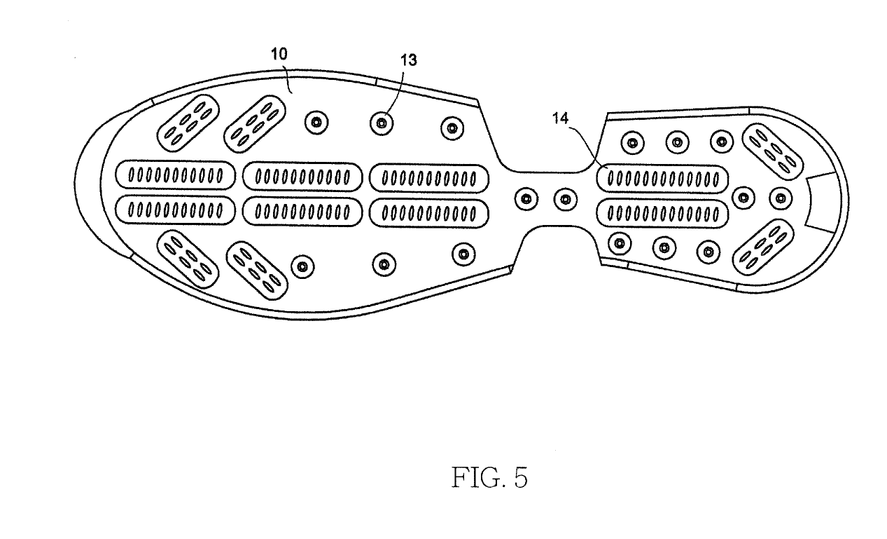

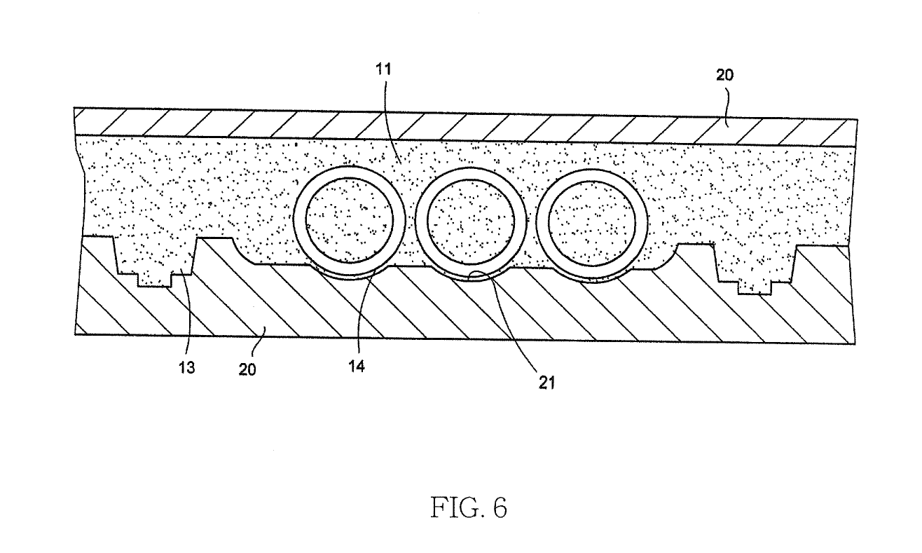

The present invention provides an anti-slip safety device, which is a practical design that achieves positive slip resistance, safety, and stability when used in combination with a rubber/plastic material. An embodiment applicable to shoe sole slip resistance is taken as an example for description. As shown in FIGS. 1-4, for the design of a shoe sole undersurface anti-slip structure, receiving troughs (21) are formed, in advance, in a bottom molding member (20) used for molding a shoe sole body (10) in order to receive anti-slip elements (11) therein and arranged to be spaced from each other. The troughs (21) are arranged across a span having a length that corresponds to an assembled length of the anti-slip elements (11), so that after being so arranged, relative fixing through inter-engagement can be achieved to provide an effect of positioning aid. Considering the structural design of the anti-slip elements (11), a helical bar that is formed through helically winding with proper spacing therebetween may be adopted, having an end from which a terminal loop (12) perpendicularly extends. The arrangement of the anti-slip elements (11), in the entirety thereof, is made as a design having a portion projecting out of a surface to be substantially identical in height with slip-resistant embossed patterns (13) formed on the undersurface of the shoe sole. And, being in compliance with spaced recesses between the embossed patterns (13), raced edge faces (14) of the anti-slip elements (11) are allowed to naturally project out to be exposed, where the height of the exposed portion, for regularly used shoe sole material, is generally less than 3 mm to achieve an effect of resisting relative slip through biting, and is preferably 1-3 mm according to the shoe sole shape. The receiving troughs (21) formed in the bottom molding member (20) in a successive arrangement for the purpose of receiving insertion therein are provided so that after the anti-slip elements (11) have been deposited therein and properly positioned, molding of the shoe sole body (10) can be carried out in such a way that the entire arrangement and distribution of the anti-slip elements (11) are made according to the outside shape and pattern arrangement of the shoe sole body (1) to have some of them distributed along a longitudinal axis of the shoe sole with proper spacing therebetween with additional anti-slip elements (11) arranged at front and rear end portions of the shoe shape, namely undersurfaces of the shoe tip and the shoe heel, to be slightly outward inclined at a proper inclination angle (A), whereby through biting achieved in inclined and irregular directions, an effect of slip resistance when subjected to a sideway force can be achieved. Thus, the shoe sole undersurface, when contacting the ground, may be caused by rigid, slippery, and uneven snowed and iced surface to provide slip resistance in various directions. In respect of the design of the anti-slip elements (11), besides being formed as successively and helically wound spaced rings, a design as that shown in FIGS. 5 and 6 is also feasible, where an annular frame like bar in the form of a single circular ring is used and deposited individually and a multiplicity of such individual circular rings are respectively placed, in a successive and spaced arrangement, in the mold, or being pre-formed separately as annular frames inserted into an inside portion of the rubber/plastic material wrapped bottom with additional connection bars (not shown) connecting between the separate annular frames to form a combined arrangement to enhance resistance against external forces, for being subsequently and directly embedded in the rubber/plastic material to achieve being more securely wrapped so as to provide identical raised edge faces (14) on and extending from a molded undersurface of the shoe sole body (10). The structural arrangement of the separate annular frame like bars can be made according to the shape and pattern arrangement of the shoe sole to show a peripheral arrangement of an arrow form or a circular arc form. The arrangement directions of the anti-slip elements (11) is made such that for that extending in the axial direction, arrangement is made so as to be in a linear form in the perpendicular direction and spaced from each other, while for the raised edge faces (14) that extend in opposite sides, arrangement is made so as to be mutually parallel with each other for the rings, as shown in FIG. 4. These also achieve the effect of slip resistance in both axial direction and sideway direction. Such an individual ring based design, through a spaced arrangement, also provides the same effect of use that achieves resistance against slip through successive biting.

Further, the present inventive anti-slip element (11) shows a design of having lengthwisely successively spaced and arranged or helical ring members, whose apparent feature of use is that after being integrally molded with the shoe sole body (10), in compliance with the property of bendability of the shoe sole body (10), in stepping and treading, deformation of bending can be achieved so that on the one hand, wear comfortableness and ground surface compliance are not affected, the exposed raised edge faces (14) may positively follows the curving of the contacted surface to curve and deform, achieving positive insertion and biting of being in complete compliance with a snowed/iced surface, providing an anti-slip wear and use that ensures sound stepping and anti-slip safety. In view of the arrangement and assembling of the anti-slip element (11), the recessed curved space formed on inside faces of the embossed patterns (13) on the ground contacting surface of the shoe sole body (10) is relied on to serve as filling and assembling space of the anti-slip elements (11), constituting, together with the shoe sole material, almost completely wrapped, secure bonding, achieving a purpose of secured bonding that prevents detachment and shifting. The forming of the entire anti-slip elements (11) are pre-formed with metallic stiff material, in the form of a single ring or helical and successive spaced arrangement to achieve an anti-slip effect of being mutually connected and also featuring meeting the need for slight extension/retraction and deformation, without causing the problem of the conventional single shoe spark that has insufficient support force and may get detached. Further, the design of connected spaced arrangement or helical form anti-slip elements (11) provide raised edge faces (14) showing multiple points of spaced and connected support against force induced by biting and slip resisting, ensuring secured and complete effect of reliable resistance against slip. The shoe sole material provides an almost completely wrapping structure and a secured and complete bonding with the shoe sole body (10) prevents the occurrence of potential risk of detachment and shifting. Further, the anti-slip element (11) formed through successively helically winding provides a pre-formed projecting terminal loop (12) that is provided in advance to allow, in recycling handling of the shoe sole material, the helical connection arrangement or the independent arranged annular bar to receive a connection bar to extend therethrough as an aid for easy removal through being hooked and separated by means of a tool, achieving an easy operation of separation and recycling, making it also featuring convenience for environmental protection handling. The raised edge faces (14) that are formed through projection of the anti-slip elements (11) are set substantially flush with the surfaces of the sole bottom embossed patterns (13) so that when the shoe sole is used indoors, the bottom surface of the shoe sole rubber/plastic material are almost not in contact with the floor surface, so that there will be no problems concerning discomfort of walking or scratching of the floor, making it possible for general use for both indoor and outdoor applications, thereby achieving a shoe sole anti-slip structure design that is of extreme value.

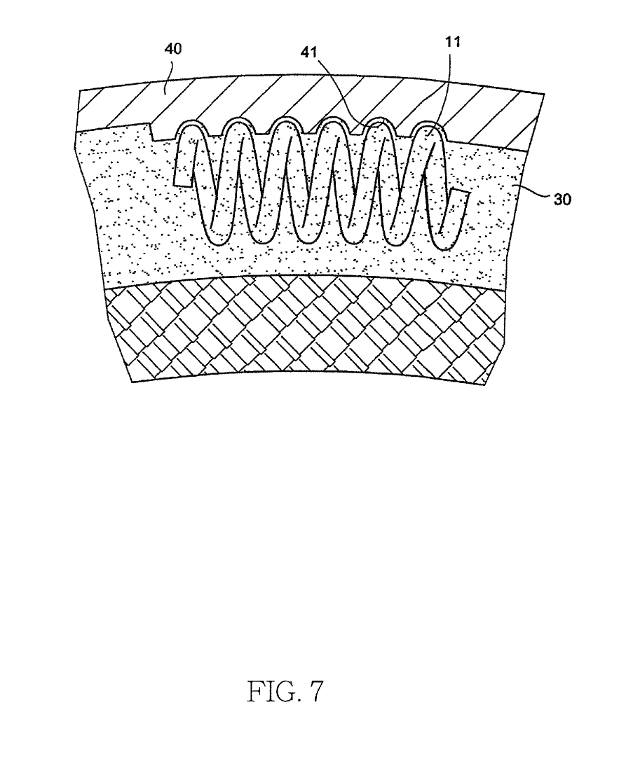

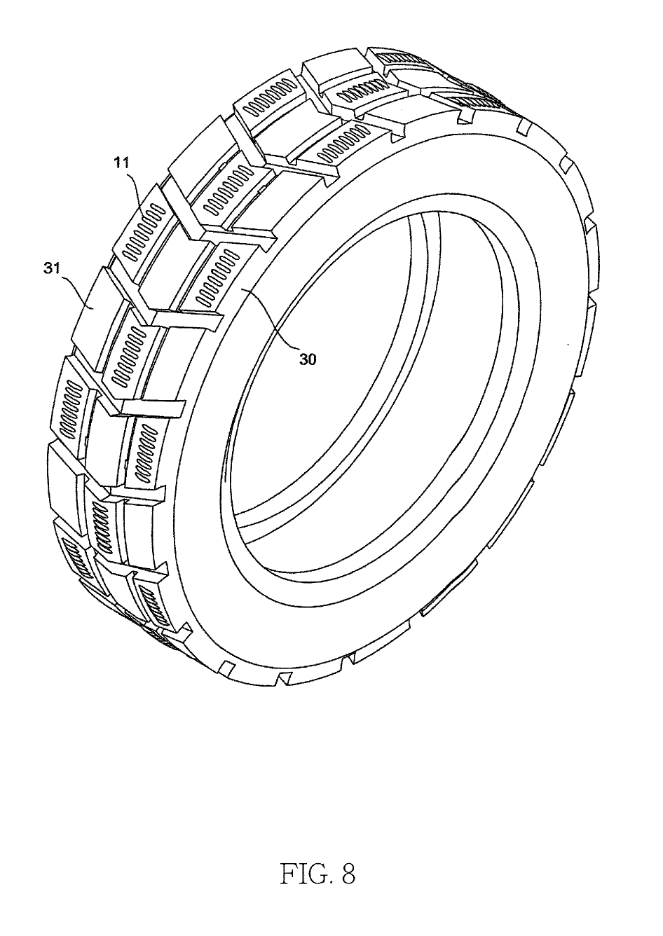

Further, the present invention provides an anti-slip design that is also applicable to anti-slip use and assembling of large and small treads that are generally molded with rubber. As shown in FIGS. 7 and 8, metal-made pre-formed helical-shaped anti-slip elements (11) re provided. A mold member (40) for molding an outer layer (30) of a tire is provided, in advance, with slightly inwardly recessed receiving troughs (41) at locations corresponding to spaced curved faces of the tire tread pattern for receiving the anti-slip elements (11) to be positioned therein. Then, a rubber/plastic material for the tire is filled for a molding operation so that the anti-slip elements are completely wrapped with the outer tire layer (30) for effecting molding in such a way that they are alternately arranged in the curved faces of the tread pattern (31) of the tire surface and slightly project out by a distance approximately less than 5 mm. The alternate and uniform arrangement is made across the curved surface of the entire tire and practical selection of the structural ring sizes, uses, and arrangement direction can be made according to the loading and location of complying with the ground surface of the tire to provide a proper use and change of design, allowing a vehicle to travel on a snowed and iced road with the metal ring edge of the projecting and exposed raised edge faces of the anti-slip element (11) positively and easily biting into a surface layer of the ice to achieve a practical effect of slip resistance for vehicle travel and eliminating the inconvenience of assembling a conventional snow chain and the trouble of detachment of the chain, making is particularly suitable for use in countries of high latitudes and achieving a use for safety and anti-slip of vehicle travel. In view of the structural design of safety and slip resistance for rotation of tire, the invention is a novel and improved design that has never been made available in the kind of anti-slip arrangements known previously.

The features of the present invention are that anti-slip elements (11) are made in a design of a hollow coiled metal stiffness wire comprising a helically continue suitable length to provide an arrangement for being completely wrapped and integrated in the molding of a shoe sole body (10) without any concern of falling or separating. Further, they are arranged to comprise raised edge faces (14) that project slightly beyond an undersurface of the shoe sole with the projecting distance being arranged in a design of being substantially flush with embossed patterns (13) formed on the undersurface of the shoe sole so that in indoor use, there is no concern regarding the projection scratching and damaging the indoor floor surface. In use for walking on an outdoor iced and slippery ground surface, the shoe sole complies with the raised and recessed uneven ground surface to be in close engagement with the ground surface so that when the sole undersurface embossed patterns (13) are deformed resulting from slipping, the stiff material made raised edge faces (14) do not undergo deformation, allowing biting into the surface layer of snow and ice, achieving comfortableness of walking and suitable safety anti-slip effect. The entirety of the anti-slip structure, in combination with a proper design of arrangement, achieves positive safety of anti-slip during walking or serves as an aid for safety anti-slip use for rotation of a tire. The entire arrangement of the anti-slip element (11) and the assembling and molding operation thereof, through aid of positioning that is provided in advance in a molding member, allow lowering down of the manufacturing techniques to have a direct advantage of lowering down the overall manufacturing cost. The successively coiled anti-slip element (11) can be replaced by a conventional elastic element having a proper length of spaced coils or can be of a linear form or can be directly designed as an assembly in the form of interconnected elements with proper inclination angles. The assembling and manufacturing of the entire anti-slip device provides easy and versatile practical advantage of anti-slip. The anti-slip element (11) that is directly formed by having spaced arranged raised edge faces (14) projecting out and interconnected according to the present invention is a completely novel design of the kind of anti-slip devices and provides a practical advantage of slip resistance, which has never been demonstrated previously for the practical advantage of slip resistance. In view of the easy and stable design of structure, this is a novel structural design of the shifting and slipping prevention for shoe soles or tires.

In summary, the present invention provides an anti-slip safety device, which uses successively arranged spaced anti-slip element with a structure of interconnected slightly projecting raised edge faces to provide the undersurface of a shoe sole with practical advantages of stable bonding and safety ant-slip.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An anti-slip safety device, comprising a rubber/plastics molded shoe sole body and anti-slip embossed patterns of raised-recessed arrangements formed on an undersurface thereof; characterized in that when in the molding of a shoe sole body, according to spacing of the arrangement of the embossed pattern, receiving troughs that are arranged to be spaced from each other are formed in advance, through recessing, in a bottom molding member to receive stiff hollow anti-slip elements to be positioned therein for being integrally molded with the shoe sole body, whereby after the molding, the anti-slip elements are embedded in spacing recessed portions between the embossed patterns with raised edge faces that are arranged to be spaced from each other exposed to achieve a purpose of slip resistance through biting into a ground surface with the stiffness thereof.

2. The anti-slip safety device according to claim 1, wherein the raised edge faces of the anti-slip elements project outward by a distance less than 3 mm.

3. The anti-slip safety device according to claim 1, wherein the raised edge faces of the ant-slip elements project outward by a distance that is substantially flush with height of the embossed patterns.

4. The anti-slip safety device according to claim 1, wherein the anti-slip elements are primarily arranged to be spaced along a longitudinal axis and additionally provided at front and rear ends of the shoe sole with an arrangement of slightly inclined outward to achieve resistance against slip in a sideway direction.

5. The anti-slip safety device according to claim 1, wherein the anti-slip elements each have an end from which a terminal loop extends.

6. The anti-slip safety device according to claim 1, wherein the anti-slip elements are each made up of individual annular frames in the form of hollow circular rings that are arranged in a successive manner for being subjected to the molding.

7. The anti-slip safety device according to claim 1, wherein the anti-slip elements are each comprise a helical bar that is hollow and is formed through continuously winding to show spacing therebetween.

8. The anti-slip safety device according to claim 7, wherein the anti-slip elements are each an elastic element having spaced helical turns.

9. An anti-slip safety device, which comprises a tire body and raised tread patterns formed on a curved surface of an outer layer thereof for slip resistance and characterized in that metal-made helical pre-formed anti-slip elements are provided and slightly recessed receiving troughs are formed, in advance, in a molding member of the outer layer of the tire on spaced curved faces of the tread to receive the anti-slip elements there in for being molded with a rubber material so as to be directly and completely wrapped and molded whereby the anti-slip element are arranged alternately on the curved faces of the tire tread patterns in an alternate and uniform arrangement on an outside surface of the tire, allowing the anti-slip elements, through the stiffness of the material thereof, to slightly bite into an iced road surface, achieving a practical purpose of safety and slip resistance for vehicle traveling.

10. The anti-slip safety device according to claim 9, wherein the anti-slip elements are arranged alternately on the curved faces of the tire tread patterns and slightly projecting outward by a distance less than 5 mm.

11. The anti-slip safety device according to claim 9, wherein selection of structure ring size and use and arrangement direction of the anti-slip elements is made according to practical needs for tire loading and ground engaging location.
